(19) United States
(12) Patent Application Publication
(10) Pub. No.: US 2018/0208883 A1
(43) Pub. Date: Jul. 26, 2018

(54) WINE ADDITIVE

(71) Applicant: WINERX, LLC, Cape Charles, VA (US)

(72) Inventor: Jennifer Corcoran, Cape Charles, VA (US)

(21) Appl. No.: 15/845,844

(22) Filed: Dec. 18, 2017

Related U.S. Application Data
(60) Provisional application No. 62/435,446, filed on Dec. 16, 2016.

(51) Int. Cl. C12H 1/14; C01B 15/01; A23L 15/00

(52) U.S. Cl. CPC C12H 1/14; A23L 15/00; C01B 15/01

(57) ABSTRACT

The present application provides compositions, methods of making the compositions, methods of use the compositions, and kits having instructions for making the compositions for mitigating the negative effects and headache symptoms produced by tannins and sulfites found in wine when consumed. In a version of the application, the composition comprises an aqueous solution comprising quantities of hydrogen peroxide and egg white powder.

This application is based upon and claims the priority filing date of the previously filed, copending U.S. Provisional patent application entitled “An additive to reduce sulfites and tannins in wine” filed Dec. 16, 2016, Ser. No. 62/435,446, the entire disclosure of which is hereby incorporated herein by reference.

### FIELD OF INVENTION

The present invention relates to the field of compositions and methods, particular additives for reducing the negative effects of consuming wine.

### BACKGROUND

Wine is an alcoholic beverage made form grapes and fermented without the addition of sugars, acids, enzymes, water, or other nutrients. Different varieties of grapes and strains of yeast produce different styles of wine. These variations result from the complex interactions between the biochemical development of the grape, reactions involved in fermentation, the terroir, and the production process.

In the context of wine production, terroir is a concept that encompasses the varieties of grapes used, elevation and shape of the vineyard, type and chemistry of soil, climate and seasonal conditions, and the local yeast cultures. The range of possible combinations of these factors can result in great differences among wines, influencing the fermentation, finishing, chemical composition and aging processes as well.

Many people enjoy the experience of drinking wine, particularly when participating in a social outing, such as during a night out or even a wine tasting event. However, many wine consumers complain of headaches, nausea, indigestion, bloating, flushed face and fatigue during and after consuming even the smallest amounts of wine. Typically, these types of symptoms occur as a result of simply ingesting too much alcohol. However, often, these symptoms are a response to not only the alcohol in the wine, but other chemicals found in the wine such as sulfites, tannins, and sugar.

The term sulfites in an inclusive term for sulfur dioxide (SO₂), a preservative that is widely used in winemaking for its antioxidant and antibacterial properties. SO₂ plays an important role in preventing oxidization and maintaining a wine's freshness.

Overall, wine is perishable and subject to legal storage conditions. Since 1987, the FDA requires that all wines containing sulfites must be labeled as such. In the U.S., there are very few wines that are made without some use of sulfites. The FDA estimates that up to 1% of the population has an increased sensitivity to sulfites and estimates that more than 1% will say they experience headaches and other symptoms. Sulfite sensitivity can vary in degree, with one or more of a combination of symptoms. They are often enough to keep someone from enjoying a glass of wine to avoid the symptoms.

Tannins occur naturally in wines and protect the wine. Tannin is a naturally occurring polyphenol found in plants, seeds, bark, wood, leaves and fruit skins. About 50% of the dry weight of plant leaves are tannins. As a characteristic of wine, tannin adds both bitterness and astringency, as well as complexity. Wine tannins are most commonly found in red wine, although white wines have tannin from being aged in wooden barrels. Tannins are great for providing a drying sensation in your mouth during consumption, particular with regard to red wines. However, like sulfites, tannins may cause some people to experience heightened levels of headaches, nausea, and dry mouth.

For the foregoing reasons, there is a need for an improved additive which assists in mitigating some of the unwanted characteristics and effects of consuming wine which contain sulfites and tannins.

### SUMMARY

The present application provides compositions, methods of making the compositions, methods of use the compositions, and kits having instructions for making the compositions for mitigating the negative effects and headache symptoms produced by tannins and sulfites found in wine when consumed.

In a version of the application, the composition comprises an aqueous solution comprising: hydrogen peroxide having a concentration of about 2.5% to about 3.5%; and egg white powder having a concentration of about 15 g/L to about 18 g/L (grams per Liter). Preferably, in a version, the concentration of hydrogen peroxide is about 3% and the concentration of egg white powder is about 15.5 g/L.

The application may further comprise a method of producing a compound for reducing the negative effects caused by sulfites and/or tannins found in wine, the method comprising the steps of: a) providing a first volume of an aqueous solution comprising about 35% hydrogen peroxide by volume; b) adding distilled water to the first volume, wherein the quantity of water brings the concentration of the hydrogen peroxide to about 2.5% to about 3.5%; c) providing a quantity of egg white powder, and d) mixing the quantity of egg white powder to the second volume, wherein the quantity of egg white powder brings the concentration of egg white powder to from about 15 g/L to about 18 g/L.

In yet another version of the application, a method for reducing the negative effects of a volume of wine containing sulfites and/or tannins is provided, the method generally comprises the steps of: providing a volume of a composition comprising an aqueous solution comprising: a) hydrogen peroxide having a concentration of about 2.5% to about 3.5%; b) egg white powder having a concentration of about 2.5 g/L to about 3.5 g/L; and c) adding a quantity of the composition to the volume of wine. The quantity of composition added can be adjusted according to the consumer needs, type of wine, and amount of wine.

In other certain versions, the application may comprise a kit for producing a composition for reducing the negative effects of a volume of wine containing sulfites and/or tannins, the kit comprising: a) a quantity of water; b) a quantity of hydrogen peroxide; c) a quantity of egg white powder; and d) instructions to use the aqueous solution, hydrogen peroxide, and egg white powder to produce the composition.

In a version of the kit, the instructions may comprise the following instructions: add the quantity hydrogen peroxide to the water; producing an aqueous solution comprising the water and the quantity of hydrogen peroxide; add the quantity of egg white powder to the aqueous solution; and add a quantity of the composition to the volume of wine.

They also experience different levels of each of these adverse events. This solution can be used and adjusted to the level of severity of the reaction, by reducing or adding the number of drops to a glass or bottle of wine. These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a report showing a control profile of a 5 ounce portion of red wine;

FIG. 2 is a report showing the profile of red wine after the addition of a first quantity of a version of the composition;

FIG. 3A-3B is a report showing the profile of red wine after the addition of a second quantity of a version of the composition;

FIG. 4 is a report showing the profile of red wine after the addition of a third quantity of a version of the composition;

FIG. 5 is a radar plot showing a control profile of a quantity of red wine;

FIG. 6 is a radar plot showing the profile of red wine after the addition of a first quantity of a version of the composition;

FIG. 7 is a radar plot showing the profile of red wine after the addition of a second quantity of a version of the composition; and

FIG. 8 is a radar plot showing the profile of red wine after the addition of a third quantity of a version of the composition.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices and methods are omitted so as not to obscure the description of the present invention with unnecessary detail.

Moreover, the description is not to be taken in the limiting sense, but is made merely for the purpose illustrating the general principles of the invention, since the scope of the invention is best defined by the appended claims. Various inventive features and methods are described below that can each be used independently of one another or in combination with other features.

Unless otherwise defined, all technical terms used herein have the same meaning as commonly understood by one of ordinary skill in the art to which the invention belongs. As used in the specification and the appended claims, the singular forms “a,” “an,” and “the” include plural references unless the context clearly dictates otherwise. Any reference to “or” herein is intended to encompass “and/or” unless otherwise stated.

The term “tannin” or “tannins” as used herein refers to an astringent, bitter plant polyphenolic compound that binds to and precipitates proteins and various other organic compounds including amino acids and alkaloids. Testing has concluded that tannins are generally incompatible with gelatin, metallic salts and strong oxidizing agents and form complexes that precipitate in aqueous solution.

The term sulfites as used herein refers to compounds that contain the sulfite ion. Sulfites occur naturally in all wines to some extent. Sulfites are commonly introduced to arrest fermentation at a desired time, and may also be added to wine as preservatives to prevent spoilage and oxidation at several stages of the winemaking. Sulfur dioxide (SO2) protects wine from not only oxidation, but also from bacteria.

The present application provides compositions, methods of making the compositions, methods of use the compositions, and kits having instructions for making the compositions for mitigating the negative effects and headache symptoms produced by tannins and sulfites found in wine when consumed.

A preferred version of the composition comprises an aqueous solution comprising: a) hydrogen peroxide (H₂O₂) having a concentration of about 2.5% to about 3.5%; and b) egg white protein powder having a concentration of about 15 g/L to about 18 g/L.

Hydrogen peroxide is a chemical compound with the formula H₂O₂. Hydrogen Peroxide is used as an oxidizer which is a substance that has the ability to oxidize other substances, in other words to cause them to lose electrons. Other common oxidizing agents include oxygen and the halogens. Generally, an oxidizing agent is a chemical species that undergoes a chemical reaction that removes one or more electrons from another atom. In that sense, it is one component in an oxidation-reduction (redox) reaction. In the second sense, an oxidizing agent is a chemical species that transfers electronegative atoms, usually oxygen, to a substrate.

In a first function, an oxidizing agent is a chemical species that undergoes a chemical reaction that removes one or more electrons from another atom. In that sense, it is one component in an oxidation-reduction (redox) reaction. In a second function, an oxidizing agent is a chemical species that transfers electronegative atoms, usually oxygen, to a substrate.

Thus, through testing it has been discovered that hydrogen peroxide reduces sulfites to sulfates. The positive charge of the protein is attracted to the negative charge of the phenolics. The protein binds to the open Hydrogen bond of the phenolics.

Preferably, the composition comprises an aqueous solution comprising about 2.5% to 3.5% Hydrogen Peroxide in order to neutralize the sulfites in the wine by transforming the sulfites into sulfates. Testing has shown that levels of Hydrogen Peroxide above 3.5% is undesirable because it tends to negatively affect the taste and flavor of the wine. Testing has also shown that levels below 2.5% are less effective. Preferably, the amount of Hydrogen Peroxide is about 3%.

Egg white is the name for the clear liquid (also called the albumen or the glair/glaire) contained within an egg. Egg white consists primarily of about 90% water into which is dissolved about 10% proteins (including albumins, mucoproteins, and globulins). Unlike the yolk, which is high in lipids (fats), egg white contains almost no fat, and carbohydrate content is less than 1%. Egg whites contain just over 50% of the protein in the egg.

Egg whites are available in the form of a powder, namely, egg white powder. Typically, in order to create an egg white powder, egg white is heated and baked for several hours, then ground to a powder form by way of a grinder. The powder form is desirable because the egg white is cooked, thereby preventing the possibility of the existence bacteria. Moreover, the powder form is preferable because of its inherent ability to easily mix with fluids.

Egg white is a fining agent that can be used in the clarification and stabilization of wine. Testing has revealed that proteins in the egg white generally have a positive charge which attracts to the negative charge of the tannins and polyphenols found in wine, particularly with regard to red wines. Thus, the proteins bind to the open Hydrogen bond of the phenolics. Because egg white powder is naturally sourced, they provide desired characteristics that provide a long shelf life.

Preferably, the composition aqueous solution has a concentration of about 15 g/L to about 18 g/L of egg white powder. Testing has shown that levels of egg white powder above 18 g/L do not properly mix with the aqueous solution and levels below 15 g/L did not provide favorable results regarding a reduction in phenolic profiles.

Sunflower lecithin is a product in the egg white powder protein. Sunflower Lecithin is a phospholipid based dietary supplement rich in Phosphatidylcholine (PC), Phosphatidylinositol (PI), Phosphatidylethanolamine (PE) and Omega-6 (Linoleic Acid), which may assist in lowering tannins in the wine.

Overall, both the Hydrogen Peroxide and the Egg white powder act collectively to counter the negative effects of wine by reducing the sulfites and tannins found therein. Moreover, both substances are natural ingredients inherently providing a strong shelf life and free from contamination than other substitutes.

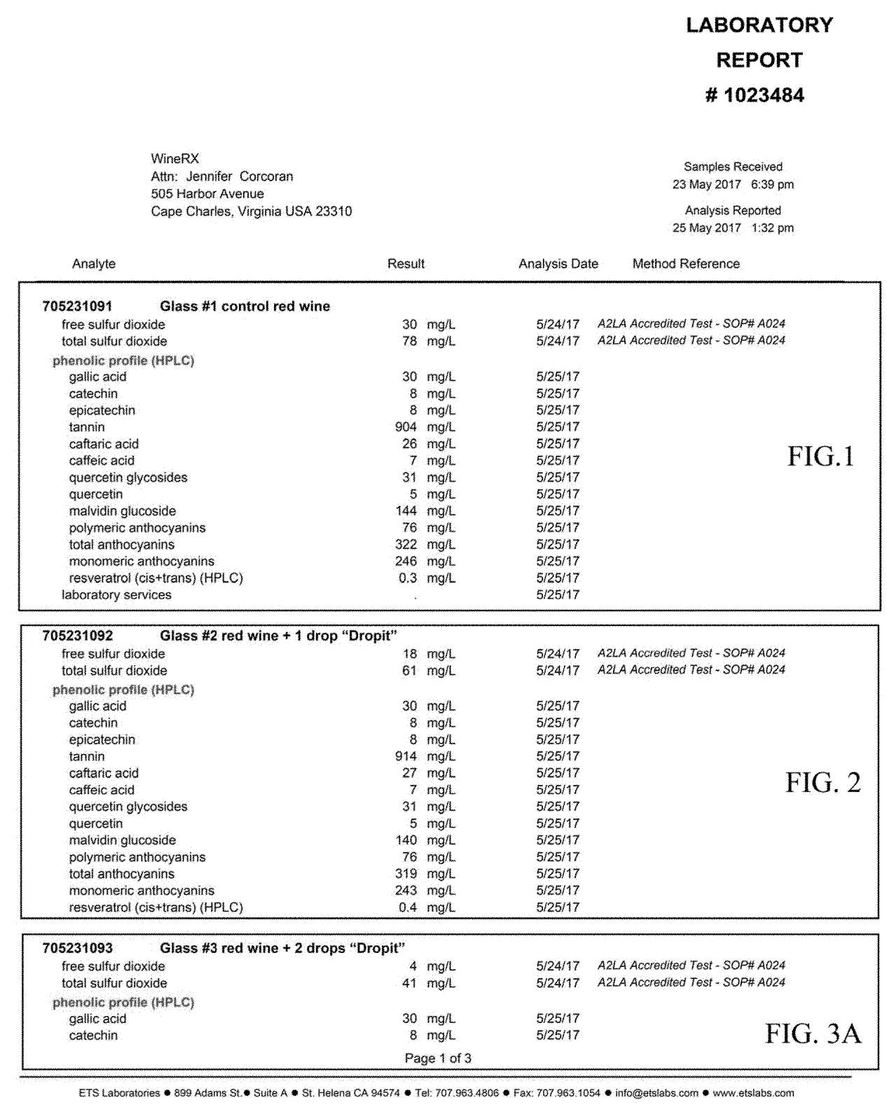

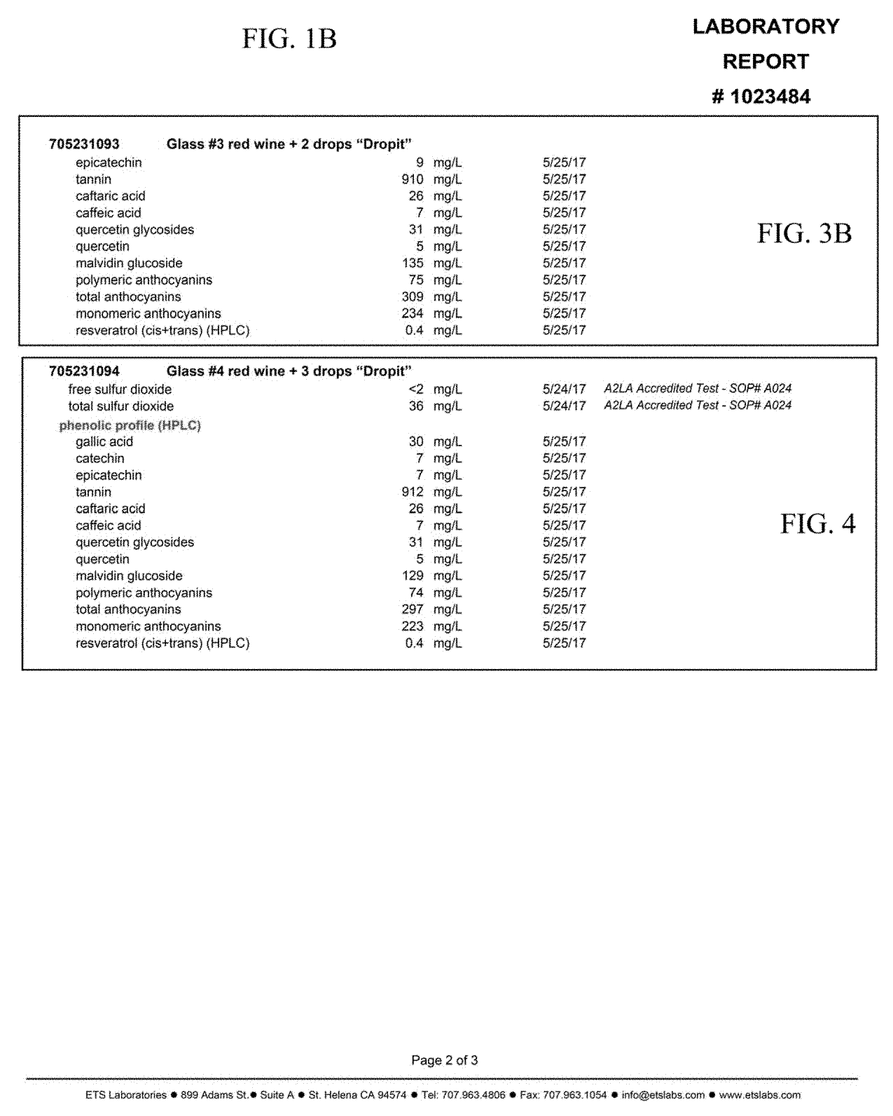

FIG. 1-FIG. 4 show the profile of a sample of wine after each addition of a quantity of the composition listing the amounts of sulfur dioxide and phenolic. The version of the composition utilized for the testing comprises an aqueous solution comprising: a) hydrogen peroxide having a concentration of about 3%; and b) egg white protein powder having a concentration of about 15.5 g/L.

FIG. 1 is a report listing the phenolic and sulfur dioxide profiles of a control glass of wine without the addition of the composition. FIG. 2 is a report showing the profile of red wine after the addition of a single drop of the composition. A drop is approximately 0.0476 ml. FIG. 3A-3B is the combined report showing the profile of red wine after the addition of two drops of the composition. FIG. 4 is a report showing the profile of red wine after the addition of a third drop of the composition. The report shows that with the addition of each greater amount of the composition, both, in combination, the amount of sulfites and the phenolic profiles are significantly reduced, providing superior results when compared to other compositions.

The test report results show that the hydrogen peroxide within the aqueous solution added to the wine becomes most effective at approximately 2 drops. It is noted that this amount is best suited for white and sparkling wines. White and sparkling wines do not require additional drops to be effective because the levels of sulfites are reduced below 10 mg/L.

Regarding the phenolic profiles, the testing has shown that a larger quantity of the composition is needed in order to lower aspects of the phenolic profiles or pre-tannins (catechin and epicatechin). Further, the results show a reduction in malvidin, monomeric anthocyanins, catechin and epicatechin. However, it is undesirable to reduce the phenolic profile beyond certain amounts, because the phenolic profile of red wine is responsible for certain robust flavors.

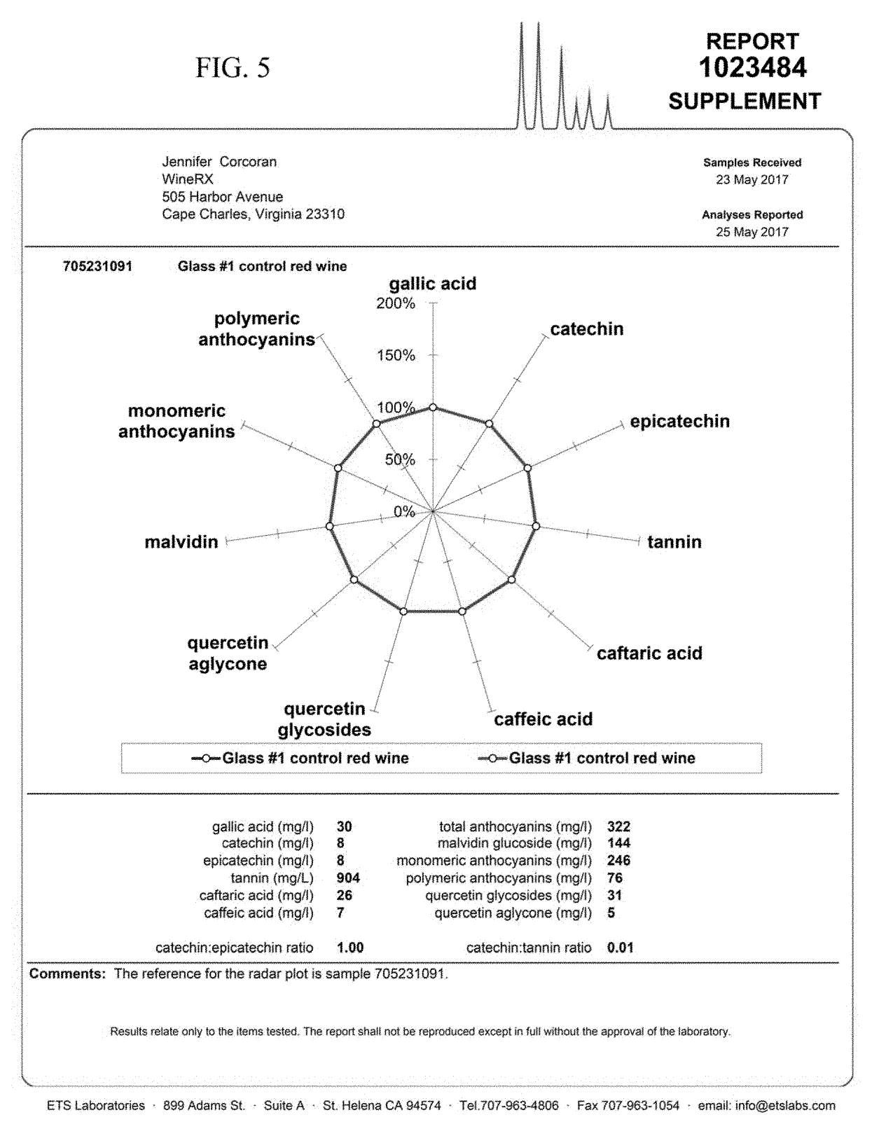

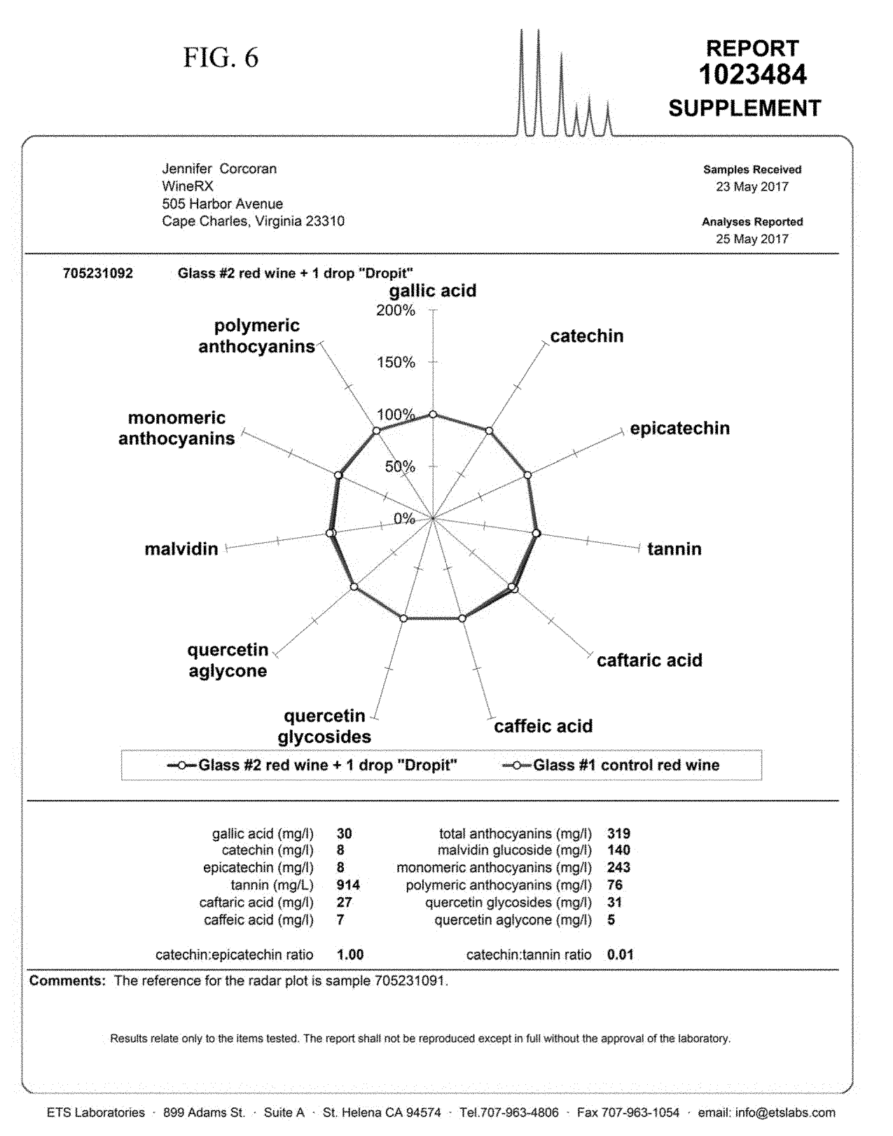

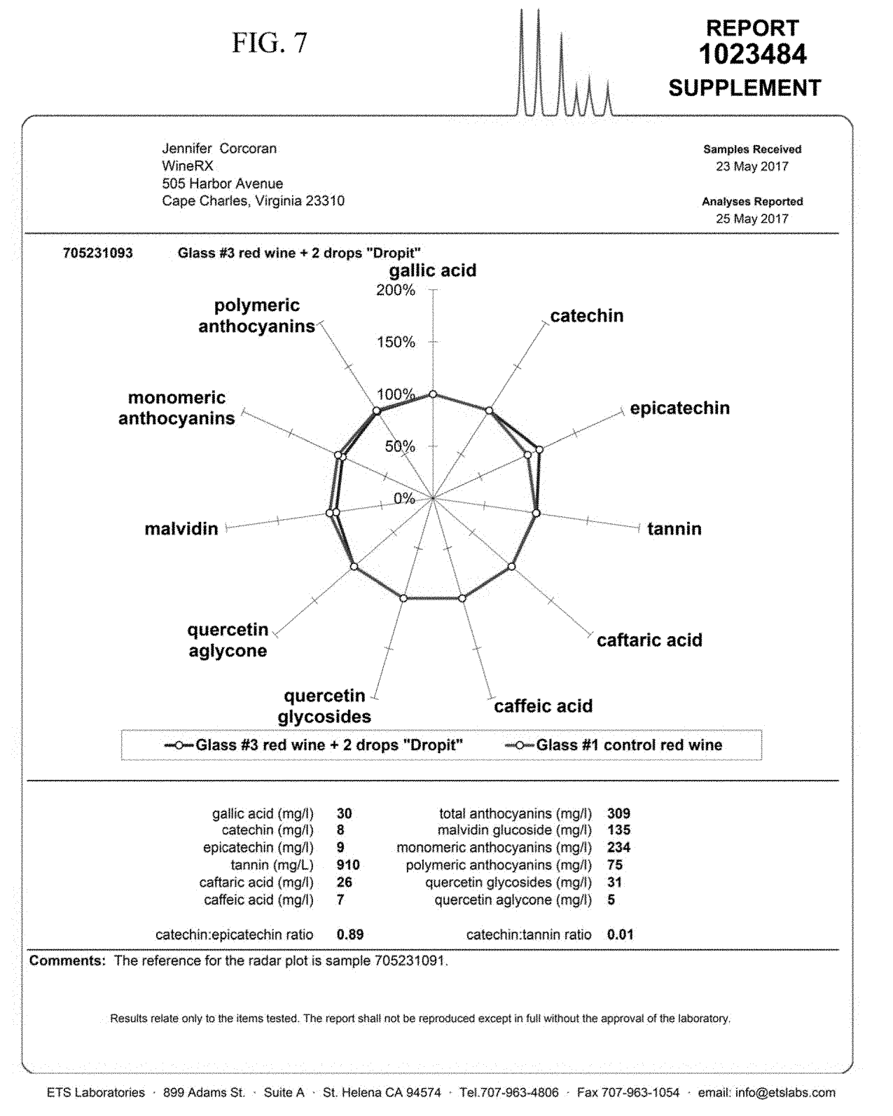

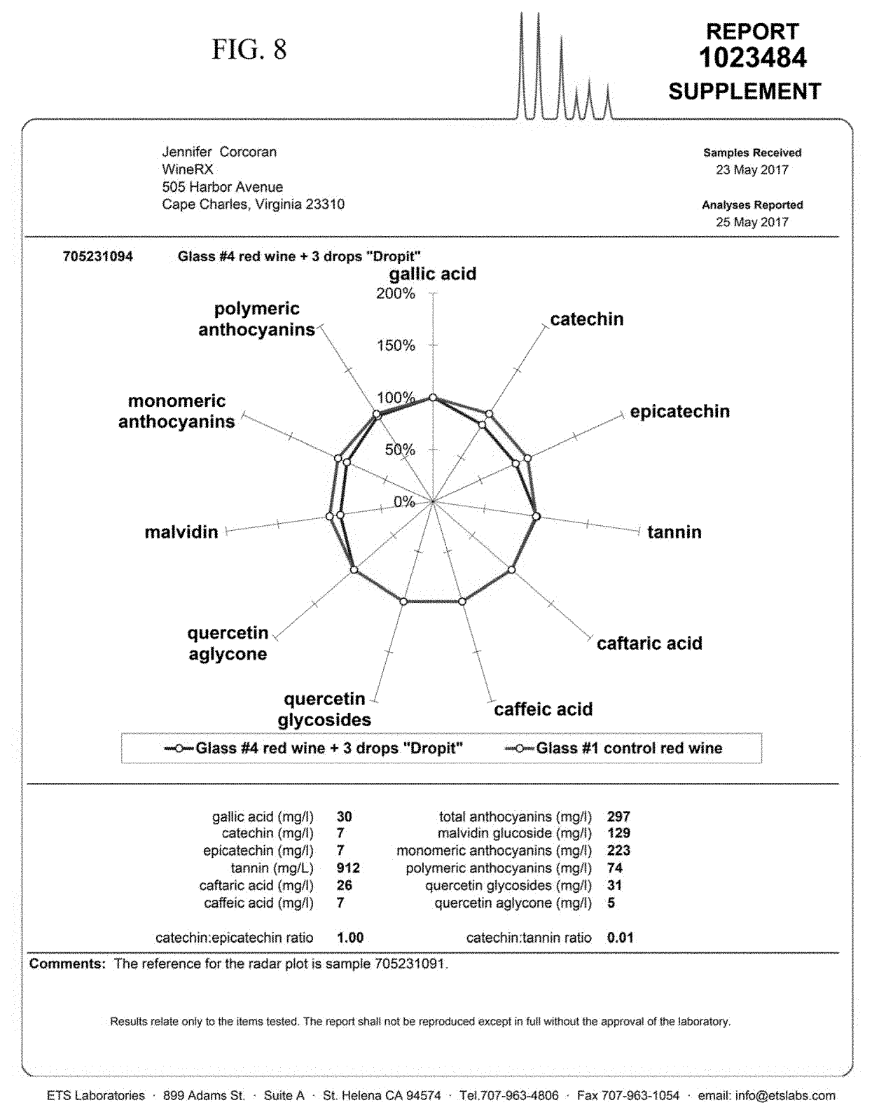

FIG. 5-FIG. 8 depict radar graphs which illustrate the phenolic profiles of a control glass of wine without the addition of the composition (FIG. 5), with the addition of one drop of composition (FIG. 6), with the addition of two drops of composition (FIG. 7), and with the addition of three drops of the composition (FIG. 8). The radar graphs generally illustrates the need of several drop of composition in order to effectively reduce the phenolic profile of the red wine. It is noted that 1-2 drops do not have a significant impact regarding the reduction of the phenolics or pre-tannins. Therefore, for those who enjoy white wine, preferably only need to apply 1-2 drops per glass in order to address the sulfites and those who prefer red wine may need at least 3 drops per glass to counter both the sulfites and tannins contained therein. This is important for those individuals that claim being able to drink a white wine, but not a red wine without adverse events. The amount of added composition by way of drops in a glass of wine or bottle may be adjusted according to the consumer, type of wine, and amount of wine.

The present application also provides a unique method of producing a version of the compound for reducing the negative effects caused by sulfites and/or tannins found in wine. The method generally comprises the steps of a) providing a first volume of an aqueous solution comprising about 35% food grade hydrogen peroxide by volume; b) adding distilled water to the first volume of an aqueous solution, wherein the quantity of water brings the concentration of the hydrogen peroxide to about 2.5% to about 3.5%; c) providing a quantity of egg white powder; and mixing the quantity of egg white powder to the second volume, wherein the quantity of egg white powder brings the concentration of egg white powder to from about 15 g/L to 18 g/L.

Moreover, the present application is directed towards a unique method for reducing the negative effects of a volume of wine containing sulfites and/or tannins, the method comprising the steps of: a) providing a volume of a composition comprising an aqueous solution comprising: a) hydrogen peroxide (H₂O₂) having a concentration of about 2.5% to about 3.5%; b) egg white protein having a concentration of about 2.5 g/L to about 3.5 g/L; and c) adding a quantity of the composition to the volume of wine.

Typically, the volume of wine is approximately 5 ounces or 147 ml which is the standard for a glass of wine. Preferably, the quantity of composition added to the glass of wine is about 1 to about 4 drops or 0.0476 ml to about 0.1904 ml. Ideally, for a bottle of red wine, the quantity of the composition added is about 2 to about 3 drops or about 0.0952 ml to about 0.1428 ml. For a bottle of white wine, the preferred applied quantity of composition is about 1 to about 2 drops or about 0.0476 ml to about 0.0953 ml. For a bottle of sparkling wine, the ideal applied quantity of composition is about 1 to about 2 drops or about 0.0476 ml to about 0.0953 ml. For a rose wine, the ideal composition added is about 2 to about 3 drops or about 0.0952 ml to about 0.1428 ml.

As another example of method of use, the volume of wine is approximately 750 ml which is the standard for a glass of wine portion found in a bottle of wine found in stores. Preferably, the quantity of composition added to the 750 ml (milliliter) bottle of wine is about 6 to about 8 drops or about 0.2856 ml to about 0.3808 ml.

The amount of added composition by way of drops in a glass of wine or bottle may be adjusted according to the consumer, type of wine, and amount of wine.

The present application may further comprise a kit for producing a composition for reducing the negative effects of a volume of wine containing sulfites and/or tannins. Generally, the kit comprises a) a quantity of water; b) a quantity of hydrogen peroxide; c) a quantity of egg white protein powder, and d) instructions to use the aqueous solution, hydrogen peroxide, and egg white protein powder to produce the composition.

The instructions contained in the kit may comprise instructions to: a) add the quantity hydrogen peroxide to the water; b) producing an aqueous solution comprising the water and the quantity of hydrogen peroxide; c) add the quantity of egg white protein powder to the aqueous solution; and d) add a quantity of the composition to the volume of wine. Preferably, the instructions to add the quantity of hydrogen peroxide comprise instructions to add a quantity of hydrogen peroxide that brings the concentration of hydrogen peroxide in the aqueous solution from about 2.5% to about 3.5%. Ideally, the instructions to add the quantity of egg white protein comprise instructions to add a quantity of egg white protein that brings the concentration of egg white protein in the aqueous solution from about 15 g/L to 18 g/L.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

What is claimed is:

1. A composition comprising an aqueous solution comprising:
a) hydrogen peroxide having a concentration of about 2.5% to about 3.5%; and
b) egg white powder having a concentration of about 15 g/L to about 18 g/L.

2. The composition according to claim 1, wherein the concentration of hydrogen peroxide is about 3%.

3. The composition according to claim 1, wherein the concentration of egg white powder is about 15.5 g/L.

4. The composition according to claim 1, wherein the concentration of hydrogen peroxide is about 3% and the concentration of egg white powder is about 15.5 g/L.

5. A method of producing a compound for reducing the negative effects caused by sulfites and/or tannins found in wine, the method comprising the steps of:
a) providing a first volume of an aqueous solution comprising about 35% hydrogen peroxide by volume;
b) adding distilled water to the first volume, wherein the quantity of water brings the concentration of the hydrogen peroxide to about 2.5% to about 3.5%;
c) providing a quantity of egg white powder; and
d) mixing the quantity of egg white powder to the second volume, wherein the quantity of egg white powder brings the concentration of egg white powder to from about 15 g/L to 18 g/L.

6. A method for reducing the negative effects of a volume of wine containing sulfites and/or tannins, the method comprising the steps of:
a) providing a volume of a composition comprising an aqueous solution comprising:
i) hydrogen peroxide having a concentration of about 2.5% to about 3.5%;
ii) egg white powder having a concentration of about 2.5 g/L to about 3.5 g/L;
b) adding a quantity of the composition to the volume of wine;

7. A method of claim 6, wherein the volume of wine is about 750 ml and the quantity of the composition added to the volume of wine is about 0.2856 ml to about 0.3808 ml.

8. A method of claim 6, wherein the volume of wine is about 147 ml and is a red wine, wherein the quantity of the composition added to the volume of wine is about 0.0952 ml to about 0.1428 ml.

9. A method of claim 6, wherein the volume of wine is about 147 ml and is a white wine, wherein the quantity of the composition added to the volume of wine is about 0.0476 ml to about 0.0953 ml.

10. A method of claim 6, wherein the volume of wine is about 147 ml and is a sparkling wine, wherein the quantity of the composition added to the volume of wine is about 0.0476 ml to about 0.0953 ml.

11. A method of claim 6, wherein the volume of wine is about 147 ml and is a rose wine, wherein the quantity of the composition added to the volume of wine is about 0.0952 ml to about 0.1428 ml.

12. A kit for producing a composition for reducing the negative effects of a volume of wine containing sulfites and/or tannins, the kit comprising:
a) a quantity of water;
b) a quantity of hydrogen peroxide;
c) a quantity of egg white powder; and
d) instructions to use the aqueous solution, hydrogen peroxide, and egg white powder to produce the composition.

13. The kit of claim 12, wherein the instructions comprise instructions to:
a) add the quantity hydrogen peroxide to the water;
b) producing an aqueous solution comprising the water and the quantity of hydrogen peroxide;
c) add the quantity of egg white powder to the aqueous solution; and
d) add a quantity of the composition to the volume of wine.

14. The kit of claim 13, wherein the instructions to add the quantity of hydrogen peroxide comprise instructions to add a quantity of hydrogen peroxide that brings the concentration of hydrogen peroxide in the aqueous solution from about 2.5% to about 3.5%.

15. The kit of claim 13, wherein the instructions to add the quantity of egg white powder comprise instructions to add a quantity of egg white powder that brings the concentration of egg white powder in the aqueous solution from about 15 g/L to 18 g/L.

16. The kit of claim 15, wherein the instructions to add the quantity of egg white powder comprise instructions to add a quantity of egg white powder that brings the concentration of egg white powder in the aqueous solution from about 15 g/L to 18 g/L.
